(19) United States
(12) Patent Application Publication
(10) Pub. No.: US 2010/0300855 A1
(43) Pub. Date: Dec. 2, 2010

(54) Light Guidance Illuminating Keyboard

(76) Inventors: Shih-Chou CHEN, Hsinchu Industrial Park (TW); Yuh-Sheng Lin, Hsinchu Industrial Park (TW); Kung-Yeh Tou, Hsinchu Industrial Park (TW); Chien-Hua Chiu, Hsinchu Industrial Park (TW)

Correspondence Address: Muncy, Geissler, Olds & Lowe, PLLC, 4000 Legato Road, Suite 310, FAIRFAX, VA, 22033, US

(21) Appl. No.: 12/276,348

(22) Filed: Nov. 23, 2008

(51) Int. Cl. H01H 9/00

(52) U.S. Cl. 200/314

(57) ABSTRACT

A light guidance illuminating keyboard utilizes plural press-key devices and a base plate having plural through-holes to generate a control signal to an electronic device when a user presses down the press-key devices. A back surface of the base plate is a light guide plate on which is defined into at least one through-hole which forms an independent optical path. A side of the light guide plate is a light emitting element. When the light emitting element produces light, the light is reflected onto the through-holes on the base plate through the light guide plate and penetrates out of the through-holes, such that the press-key devices can manifest various visual effects according to the light produced by the light emitting element.

### BACKGROUND OF THE INVENTION

a) Field of the Invention

The present invention relates to an illuminating keyboard, and more particularly to a light guidance illuminating keyboard, brightness of illumination of which can be increased and press-key functions of which can be categorized by colors.

b) Description of the Prior Art

As continuous innovation of information technology, many functions which could not be imagined of previously have been able to be accomplished by a personal computer. To satisfy and even simplify controlling the computer by a user, a lot of instruction input devices arise correspondingly, wherein a computer keyboard is the input device that has been used longest, is provided with most powerful functions and is very difficult to be replaced.

In order to allow the computer keyboard to be still identified and used effectively in glimmer under weak ambient light or in a dark without ambient light, a feasible approach is to add on the computer keyboard itself with an internal light source, and an internal light generating device which is different from an existing type and is far more applicable to the computer keyboard is provided; whereas, all the existing computer keyboards that are provided with the light sources are installed internally with a light guide plate, with various designs for reflecting the light being implemented to the light guide plate. The most popular one now is to provide a rough surface, a sunk-spot area or a mesh-point area on the light guide plate, which is used to improve a reflection rate of the light source, allowing the computer keyboard to be brighter.

Yet, upon using the aforementioned computer keyboard that is provided with the light source, following issues and shortcomings actually exist to be improved:
1. Although the aforementioned light reflection method is provided with an effect to change a light path, when being reflected out, the light cannot be condensed; therefore, the light displayed will be scattered out.
2. The aforementioned light guide plate is primarily an entire plate; hence, cost cannot be reduced effectively in manufacturing, and entire weight cannot be decreased.
3. As the reflection areas on the light guide plate are made into small materials or small areas, more light emitting elements, such as light emitting diodes (LEDs) should be used to improve the brightness.

Accordingly, how to solve the aforementioned problems and shortcomings in the prior art is a technological issue of research and development for improvement by the present inventor and related vendors.

### SUMMARY OF THE INVENTION

The primary object of present invention is to provide a light guidance illuminating keyboard, wherein a plurality of press-key devices and a base plate which is provided with a plurality of through-holes are provided, such that a control signal can be generated and be transmitted to an electronic device when a user presses down a key-press device; a back surface of the base plate is provided with a light guide plate on which is defined into at least one through-hole that forms an independent optical path; and a side of the light guide plate is provided with a light emitting element, such as an LED, such that when the light emitting element produces light, the light will be reflected onto the through-holes on the base plate through the light guide plate, and penetrate out of the through-holes, allowing the press-key devices to manifest various visual effects according to the light produced by the light emitting element.

Another object of the present invention is to provide a light guidance illuminating keyboard, wherein the aforementioned light guide plate is dug out at locations without the illuminating press keys to form independent optical paths; therefore, cost can be reduced effectively in manufacturing, and entire weight can be decreased.

Yet another object of the present invention is to provide a light guidance illuminating keyboard, wherein by combination of the light guide plate and the light emitting element (LED), the keyboard can produce light of various colors at various function display areas.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of a preferred embodiment of the present invention.

FIG. 2 shows a three-dimensional exploded view of a preferred embodiment of the present invention.

FIG. 3 shows a three-dimensional schematic view of a light guide plate of the present invention.

FIG. 3A shows a local blow-up view of the light guide plate of the present invention.

FIG. 4 shows a three-dimensional schematic view of another light guide plate of the present invention.

FIG. 4A shows a local blow-up view of another light guide plate of the present invention.

### DETAILED DESCRIPTION OF THE PREFERRED EMBODIMENTS

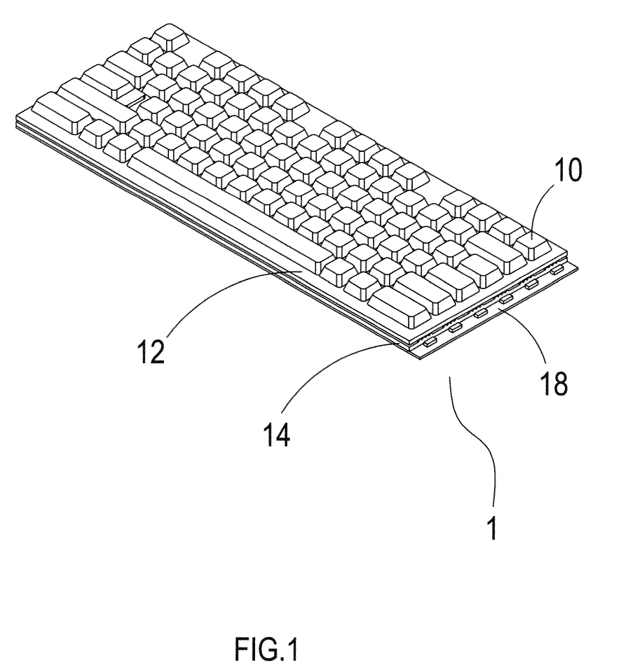

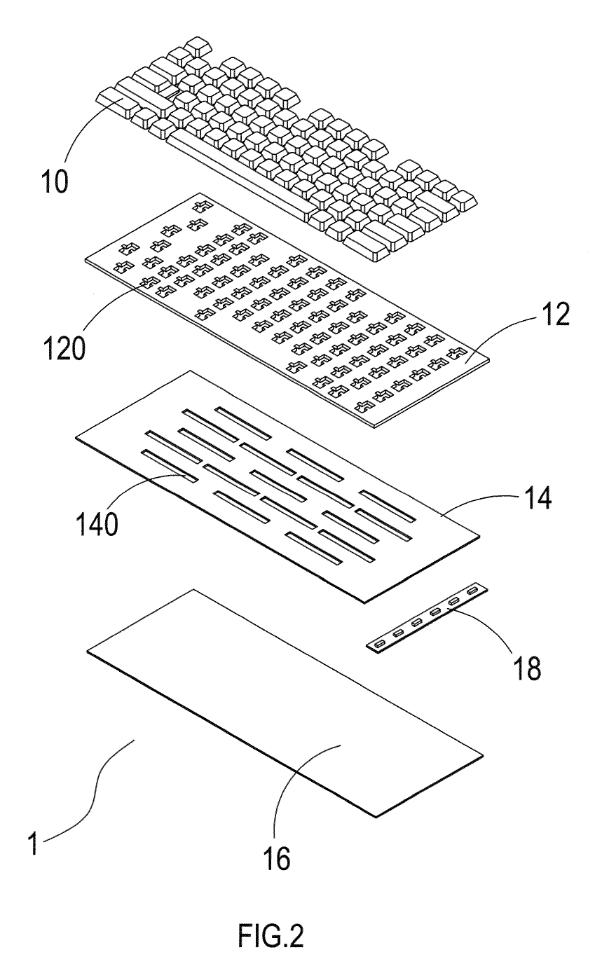

Referring to FIG. 1 and FIG. 2, it shows a three-dimensional schematic view and a three-dimensional exploded view of a preferred embodiment of the present invention. A light guidance illuminating keyboard 1 of the present invention comprises primarily a plurality of press-key devices 10, and a base plate 12 which is provided with a plurality of through-holes 120, such that a control signal can be generated and be transmitted to an electronic device (not shown in the drawings), when a user presses down the press-key devices 10. A back surface of the base plate 12 is provided with a light guide plate 14, a bottom end of which is disposed with a reflection plate 16. As a surface of the light guide plate 14 is defined into at least one through-hole 140 which forms an independent optical path, and two sides of the light guide plate 14 are provided respectively with a light emitting element 18, such as an LED, which is at an angle of a best light reflection rate with respect to the light guide plate 14, when the light emitting elements 18 produce light, the light will be reflected onto the through-holes 120 on the base plate 12 through the light guide plate 14, and penetrate out of the through-holes 120, allowing the key-press devices 10 to manifest various visual effects according to the light produced by the light emitting elements 18.

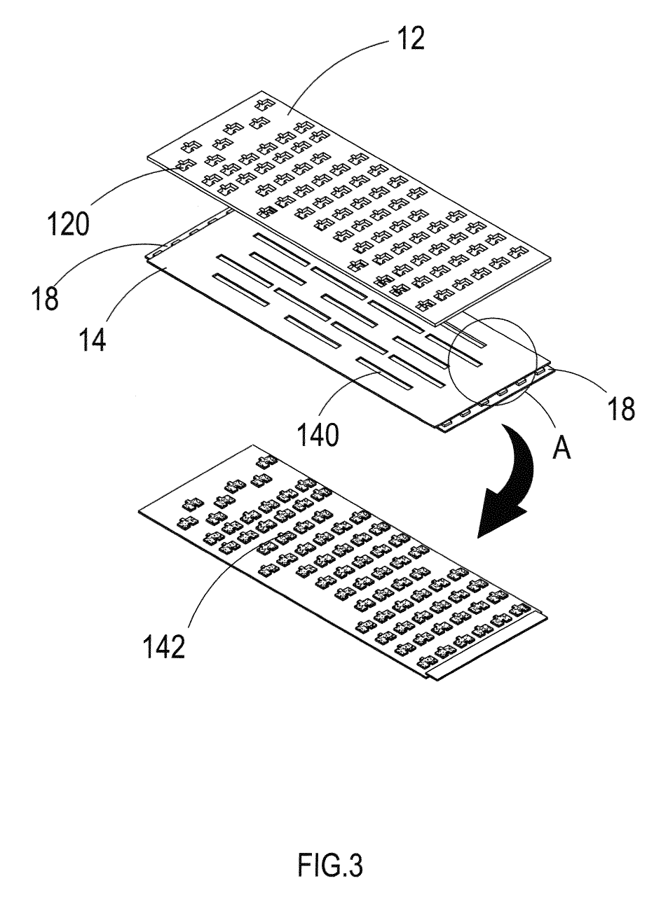

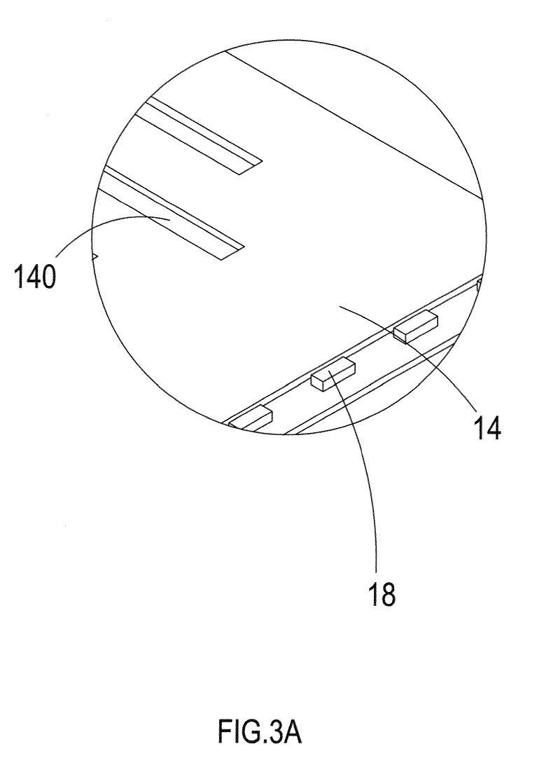

Referring to FIG. 3 and FIG. 3A, it shows a three-dimensional schematic view and a local blow-up view, of a light guide plate of the present invention. The light guide plate 14 is defined into at least one through-hole 140 that forms the independent optical path, and two sides of the light guide plate 14 are provided respectively with the light emitting element 18, such as the LED. On the other hand, a side of the light guide plate 14 is formed with a rough surface 142 which scatters the light and changes the light path. Accordingly, when the light produced by the light emitting element 18 at one side of the light guide plate 14 is reflected through the surface of the light guide plate 14, as the base plate 12 which is attached with the light guide plate 14 is provided with the plural through-holes 120, the reflected light can be projected out through the through-holes 120, allowing the light guidance illuminating keyboard 1 to categorize functions according to light of various colors.

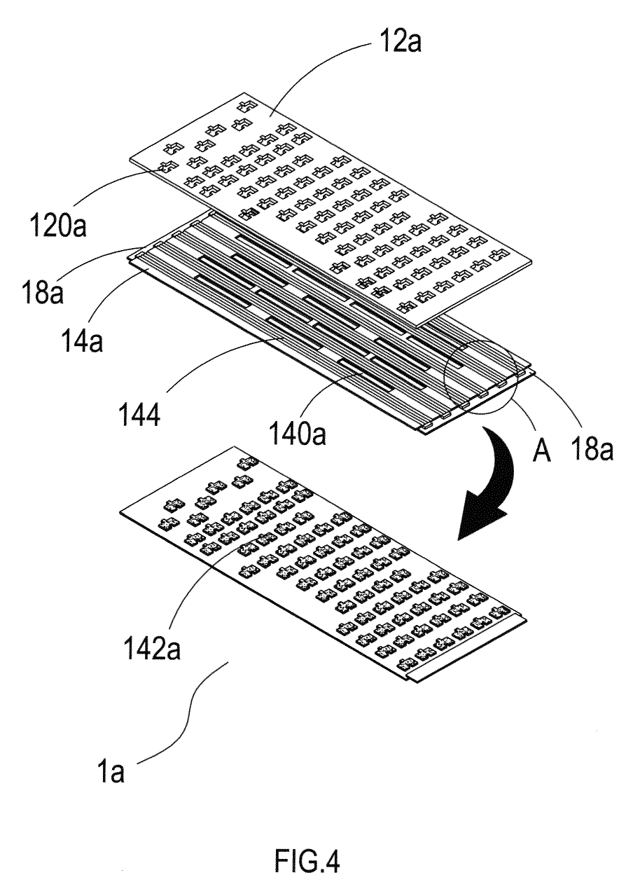

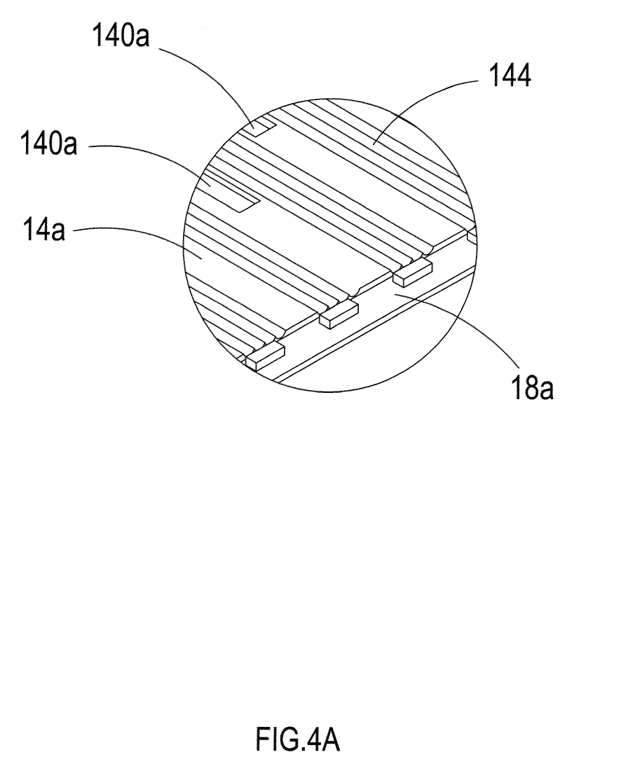

Referring to FIG. 4 and FIG. 4A, it shows a three-dimensional schematic view and a local blow-up view, of another light guide plate of the present invention. A light guide plate 14a is formed with plural light guide parts 144 which are parallel to each other (such as a V-shape pattern, a U-shape pattern or a semi-arc pattern), and a surface of the light guide plate 14a is dug out at a locations without illuminating press keys, to form through-holes 140a, enabling the light guide plate 14a to be formed with independent optical paths. On the other hand, taking a V-shape cross section of the light guide part 144 as an example, two sides of the light guide part 144 are provided respectively with a light emitting element 18a, such as an LED; whereas, a surface of the light guide plate 14a, opposite to the light guide part 144, is formed with a rough surface 142a which scatters the light and changes the light path. Therefore, when the light produced by the light emitting elements 18a at two sides of the light guide parts 144 are reflected through the surfaces of the light guide parts 144, as a base plate 12a which is attached with the light guide plate 14a is provided with plural through-holes 120a, the reflected light can be projected out through the through-holes 120a, enabling a light guidance illuminating keyboard 1a to categorize functions according to light of various colors.

Accordingly, referring to all the drawings, the present invention is actually provided with following advantages, upon using, when in comparison with the prior art:
1. When the light emitting elements 18 produce light, the light is reflected onto the through-holes 120 on the base plate 12 through the light guide plate 14, and penetrates out of the through-holes 120, allowing the press-key devices 10 to manifest various visual effects according to the light produced by the light emitting elements 18.
2. The aforementioned light guide plate 14 is dug out at the locations without the illuminating press keys, to form the independent optical paths; therefore, the cost can be reduced effectively in manufacturing and the entire weight can be decreased.
3. Accordingly, the light guide parts 144 formed on the surface of the light guide plate 14 are parallel to each other, and the light guide parts 144 (such as the V-shape pattern, the U-shape pattern or the semi-arc pattern) allow the light displayed by the press keys to be aggregated, thereby improving the effect of condensing the light.
4. As the light guide parts 144 on the surface of the light guide plate 14 (such as the V-shape pattern, the U-shape pattern or the semi-arc pattern) can condense the light effectively, utilization of the light emitting elements 18 (LED) can be saved.
5. By the combination of the light guide plate 14 and the light emitting elements 18 (LED), the light of various colors can be produced at various function display areas of the keyboard.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A light guidance illuminating keyboard, which utilizes a plurality of press-key devices, and a base plate being provided with a plurality of through-holes, so as to generate a control signal to an electronic device when a user presses down the press-key devices, comprising a light guide plate, which is provided at an end of the base plate opposite to the press-key devices and is defined into at least one through-hole that forms an independent optical path; and a reflection plate which is provided at a bottom end of the light guide plate.

2. The light guidance illuminating keyboard according to claim 1, wherein two sides of the light guide plate are provided respectively with a light emitting element which is at an angle of a best light reflection rate, with respect to the light guide plate.

3. The light guidance illuminating keyboard according to claim 1, wherein a surface of the light guide plate is formed with a rough surface.

4. The light guidance illuminating keyboard according to claim 1, wherein the light emitting element is an LED(Light-emitting diode). [symbol] press-key devices, and a base plate being provided with a plurality of through-holes, so as to generate a control signal to an electronic device when a user presses down the press-key devices, comprising a light guide plate, which is provided at an end of the base plate opposite to the press-key devices and is defined into at least one through-hole that forms an independent optical path; at least one light guide part which is provided on the base plate and is located between the through-holes; and a reflection plate which is provided at a bottom end of the light guide plate.

6. The light guidance illuminating keyboard according to claim 5, wherein two sides of the light guide plate are provided respectively with a light emitting element which is at an angle of a best light reflection rate, with respect to the light guide plate.

7. The light guidance illuminating keyboard according to claim 5, wherein a surface of the light guide plate is formed with a rough surface.

8. The light guidance illuminating keyboard according to claim 5, wherein the light guide part is in a V-shape pattern, a U-shape pattern or a semi-arc pattern.

9. The light guidance illuminating keyboard according to claim 5, wherein the light emitting element is an LED.
